(19) United States
(12) Patent Application Publication
(10) Pub. No.: US 2008/0044147 A1
(43) Pub. Date: Feb. 21, 2008

(54) Nonlinear optical device and method of forming

(76) Inventor: Navin Bhailalbhai Patel, Ocala, FL (US)

Correspondence Address: JONES DAY, 555 SOUTH FLOWER STREET FIFTIETH FLOOR, LOS ANGELES, CA, 90071, US

(21) Appl. No.: 11/505,243

(22) Filed: Aug. 16, 2006

(51) Int. Cl. G02B 6/10; G02B 6/34

(52) U.S. Cl. 385/122; 385/37

(57) ABSTRACT

A nonlinear optical device including at least a first nonlinear optical grating is provided. The first grating comprises a plurality of adjacent nonlinear optical (NLO) units. Each NLO unit has a single crystal segment and a polycrystalline segment. The single crystal segment is formed from a single crystal of a nonlinear optical material and has a length adapted to provide a nonlinear optical effect. The polycrystalline segment has a length adapted to compensate for phase mismatch that occurs in the single crystal segment. Including a polycrystalline segment in each NLO unit allows for a type of quasi-phase-matching to be achieved in the first nonlinear optical grating. The first grating may be used to form a variety of nonlinear optical devices, including, for example, frequency doublers, frequency adders, frequency subtractors, amplifiers, parametric oscillators, and optical mixers. Further, the first grating may form the core of a waveguide.

### FIELD

The present application relates to nonlinear optics and, more particularly, to devices for quasi-phase-matching for parametric nonlinear optical interactions, as well as methods of making such devices.

### BACKGROUND

Nonlinear optics is the branch of optics that describes the behavior of light as it traverses a nonlinear medium, i.e., a medium in which the polarization of constituent atoms responds nonlinearly to the electric field of the light. This phenomenon of non-linearity can be observed at very high light intensities typically provided by lasers. Through nonlinear optics, light of one wavelength may be transformed to light of another wavelength. Nonlinear optics may be used, for example, for frequency doublers, frequency adders, frequency subtractors, and optical parametric oscillators.

When light traverses through a medium, the electromagnetic intensity causes a polarization of the constituent atoms (separation of the positively charged nucleus and the negatively charged surrounding electrons), thereby creating electric dipoles. These oscillating dipoles reradiate the electromagnetic wave, but the interaction causes a reduction in the wavelength, and the velocity, of light by a factor of n, which is called the refractive index of the medium. Because this interaction can involve various resonance peaks at different wavelengths, n is in general a monotonically decreasing function of wavelength away from the resonance peaks. When light of different wavelengths travel at different velocities through a transmitting medium, the medium is said to be dispersive and this property of light is referred to as dispersion.

In nonlinear optics, dispersion interferes with the efficiency of the various parametric nonlinear optical interactions (or frequency-mixing processes). Dispersion reduces the efficiency of the frequency-mixing processes because it results in a phase-shift between the input wave(s) and the output wave(s). Eventually, the phase shift becomes large enough that the new light that is generated by the input waves is exactly 180 degrees (or π) out of phase with the original light that it produced resulting in destructive interference. As a result, as shown in curve (D) of FIG. 7, the intensity of the generated wave oscillates periodically with distance traveled through the nonlinear optical (NLO) medium, where the period of oscillation corresponds to two times the coherent length (2L_{c}). In view of the foregoing phenomenon, some type of phase-matching is necessary for any efficient nonlinear interaction to be achieved. Accordingly, a group of phase-matching techniques have been developed to improve the efficiency of nonlinear interactions.

One approach for achieving phase-matching has been to use crystals that exhibit birefringence. In this approach a birefringent crystal is used in which the difference in index of refraction due to dispersion is exactly opposite the difference in index of refraction experienced due to birefringence so that the incoming and generated waves experience the same refractive indices. When perfect phase-matching is achieved in this manner, the intensity of the generated wave increases quadratically with distance as shown in curve (A) of FIG. 7. The problem with birefringence phase-matching, however, is that there are few birefringent crystals that just happen to have both the requirements of a nonlinear material and the right birefringence so that the incoming and generated waves experience the same refractive indices, thereby maintaining phase-matching. To minimize this problem, temperature tuning and angle-tuning techniques have been developed. However, these techniques still have significant limitations.

Quasi-phase-matching was originally proposed in 1962 by Armstrong, et al. (see J. A. Armstrong, et al. Interactions Between Light Waves in Nonlinear Dielectric, Phys. Rev., 127, 1918-39 (1962)) and has been developed as an alternative to perfect phase-matching achieved by birefringence techniques. Quasi-phase-matching can be used in a variety of situations where birefringence phase matching cannot be implemented. In the quasi-phase-matching method, the frequencies involved in a frequency-mixing process are not constantly locked in phase with each other; instead, the crystal axis is flipped at a regular interval typically corresponding to the coherent length (L_{c}) of the crystal by applying strong static electric fields using patterned electrodes. These crystals are referred to as being periodically-poled, and, as seen in FIG. 5, have a period of alteration equal to twice the coherent length (2L_{c}).

The periodic inversion of the crystal axis periodically inverts the sign of the nonlinear coupling coefficient. As a result, the polarization response of the crystal is periodically shifted back in phase with that of the input wave(s). This allows a net positive energy flow from the input wave(s) to the output wave(s), and the intensity of the generated wave to increase as shown in curve (B) of FIG. 7 with distance traveled through the nonlinear optical medium. The quasi-phase-matching technique is limited, however, because periodic inversion of a crystals axis through poling has thus far only been successfully achieved on a commercial scale in a limited class of ferroelectric crystals, such as lithium niobate.

### SUMMARY

The present invention is directed to a new class of nonlinear optical (NLO) devices and methods of making such NLO devices. To this end, in one aspect of the present invention, a nonlinear optical device comprising a first nonlinear optical grating is provided.

According to one embodiment, the first nonlinear optical grating comprises a plurality of adjacent nonlinear optical units disposed in series to one another. Each NLO unit has a single crystal segment and a polycrystalline segment. The single crystal segment is formed from a single crystal of a nonlinear optical material and has a length adapted to provide a nonlinear optical effect. The polycrystalline segment has a length adapted to compensate for phase mismatch that occurs in the single crystal segment.

In one embodiment, each NLO unit as a length substantially equal to nL_{c} where n is an even number and L_{c} is the coherence length for the nonlinear optical interaction for which the grating has been designed. Further, while different NLO units preferably have substantially the same length, they may also have different lengths. More preferably, the single crystal segment of each NLO unit has a length substantially equal to xL_{c}, the polycrystalline segment has a length substantially equal to yL_{c}, and the total length of each NLO unit is substantially equal to nL_{c}, where x and y are odd numbers and n is an even number. In an alternative embodiment, the single crystal segment of each NLO unit has a length equal to xL_{c}, the polycrystalline segment has a length equal to yL_{c}, and the total length of each NLO unit is substantially equal to nL_{c}, where x and y are odd numbers or fractional numbers and n is an even number. Ideally x and y in the foregoing embodiments equal 1 so that the single crystal segment and polycrystalline segment have approximately the same length and n equals 2. Moreover, the single crystal segment preferably comprises a cubic crystal, and more preferably a noncentrosymmetric, cubic crystal. The polycrystalline segment preferably comprises the same material as that of the single crystal segment.

In a particularly preferred embodiment, L_{c} is set equal to π/|Δk|, where Δk is a phase mismatch factor equal to k₃−k₁−k₂, where k₁, k₂ and k₃ correspond to wave vectors for each light wave interacting nonlinearly and k₁=n₁ω₁/c, k₂=n₂ω₂/c and k₃=n₃ω₃/c, where ω₁, ω₂, and ω₃ correspond to the frequency of each light wave involved in the nonlinear interaction, ω₃ is the frequency of the highest frequency light wave involved in the interaction, and n₁, n₂, and n₃ equal the refractive index of the nonlinear optical material at frequencies ω₁, ω₂, and ω₃, respectively.

Including a polycrystalline segment in each NLO unit allows for a modified type of quasi-phase-matching to be achieved in the first nonlinear optical grating. However, instead of having to periodically pole the crystal to invert its axis as illustrated in FIG. 5 for the conventional quasi-phase-matching technique, the crystalline axis of each of the single crystal segments may all face in the same direction. As a result, the class of nonlinear optical materials that may be used for achieving phase-matching conditions is greatly expanded with the nonlinear optical devices of the present invention.

The first nonlinear optical grating may be used to form a variety of nonlinear optical devices, including, for example, frequency doublers, frequency adders, frequency subtractors, amplifiers, parametric oscillators, and optical mixers. While the nonlinear optical grating is preferably designed to support a second-order nonlinear interaction, the nonlinear optical grating may be configured to support higher order nonlinear optical interactions, including, for example, third and fourth-order interactions. Further, the nonlinear optical device may form the core of a waveguide.

In yet further embodiments of the invention, the nonlinear optical device may further comprise a second nonlinear optical grating. The second grating may be adjacent the first grating in a side-by-side relationship or disposed in series with the first grating. Further, the nonlinear optical gratings may comprise, for example, a grating selected from the group consisting of a uniform grating, a fan-out grating, and a chirped grating.

According to another aspect, a method for forming a nonlinear optical device adapted to provide a nonlinear optical effect is provided. The method comprises forming a first nonlinear optical grating comprising a plurality of NLO units disposed in series, wherein each NLO unit comprises a single crystal segment and a polycrystalline segment, the single crystal segment comprises a single crystal of a nonlinear optical material having a length adapted to provide a nonlinear effect, and the polycrystalline segment has a length adapted to compensate for phase mismatch occurring in the single crystal segment.

Preferably each of the NLO units are formed to have a length substantially equal to nL_{c} where n is an even number and L_{c} is the coherent length for the nonlinear optical interaction for which the NLO medium has been designed. Further, while the NLO units are preferably formed to have substantially the same length, they may also have different lengths. More preferably, the single crystal segment of each NLO unit is formed to have a length substantially equal to xL_{c}, the polycrystalline segment is formed to have a length substantially equal to yL_{c}, and the total length of each NLO unit is substantially equal to nL_{c}, where x and y are odd numbers and n is an even number. In an alternative embodiment, the single crystal segment of each NLO unit has a length equal to xL_{c}, the polycrystalline segment has a length equal to yL_{c}, and the total length of each NLO unit is substantially equal to nL_{c}, where x and y are odd numbers or fractional numbers and n is an even number. Ideally x and y in the foregoing embodiments equal 1 so that the single crystal segment and polycrystalline segment have approximately the same length and n equals 2. Moreover, the single crystal segment preferably formed from a cubic crystal, and more preferably a noncentrosymmetric, cubic crystal. The polycrystalline segment is preferably formed from the same material as that of said single crystal segment.

The method of making a nonlinear optical device may be used to form a variety of nonlinear optical devices, including, for example, frequency doublers, frequency adders, frequency subtractors, amplifiers, and parametric oscillators, and optical mixers. Moreover, while the nonlinear optical grating is preferably configured to support a second-order nonlinear interaction, the nonlinear optical grating may be configured to support higher order interactions, including, for example, third and fourth-order interactions. Further, the first nonlinear optical grating may be shaped to form the core of a waveguide, preferably a core that supports single mode light propagation.

The method according to the present aspect of the invention may further comprise the step of forming a second nonlinear optical grating. The second grating may be adjacent the first grating in a side-by-side relationship or disposed in series with the first grating. Further, the nonlinear optical gratings may comprise, for example, a grating selected from the group consisting of a uniform grating, a fan-out grating, and a chirped grating.

Further aspects, objects, desirable features and advantages of the described inventions will be better understood from the detailed description and drawings that follow in which various embodiments of the disclosed inventions are illustrated by way of example. It is to be expressly understood, however, that the drawings and description are for the purpose of illustration only and are not intended as a definition of the limits of the invention.

### BRIEF DESCRIPTION OF THE DRAWINGS

FIG. 1A is a schematic view of one embodiment of a nonlinear optical device according to the present invention employing sum-frequency generation;

FIG. 1B is an energy level description of the sum-frequency generation process;

FIG. 2A is a schematic view of another embodiment of a nonlinear optical device according to the present invention employing second-harmonic generation;

FIG. 2B is an energy level description of the second-harmonic generation process;

FIG. 3A is a schematic view of yet another embodiment of a nonlinear optical device according to the present invention employing difference-frequency generation;

FIG. 3B is an energy level description of the difference-frequency generation process;

FIG. 4 is a schematic view of a parametric oscillator according to the present invention;

FIG. 5 is a schematic view of a prior art quasi-phase-matching crystal;

FIG. 6 is a schematic view of a non-linear optical medium according to one embodiment of the present invention; and

FIG. 7 is a diagram comparing the spatial variation of the output intensity I₃ of the generated wave in a nonlinear optical interaction for four different phase matching conditions.

FIG. 8 is a perspective view of a uniform nonlinear optical grating according to the present invention.

FIG. 9 is a perspective view of a chirped nonlinear optical grating according to the present invention.

FIG. 10 is a perspective view of a fan-out nonlinear optical grating according to the present invention.

FIG. 11 is a perspective view of one embodiment of a multiple nonlinear optical grating according to the present invention.

### DETAILED DESCRIPTION OF PREFERRED EMBODIMENTS

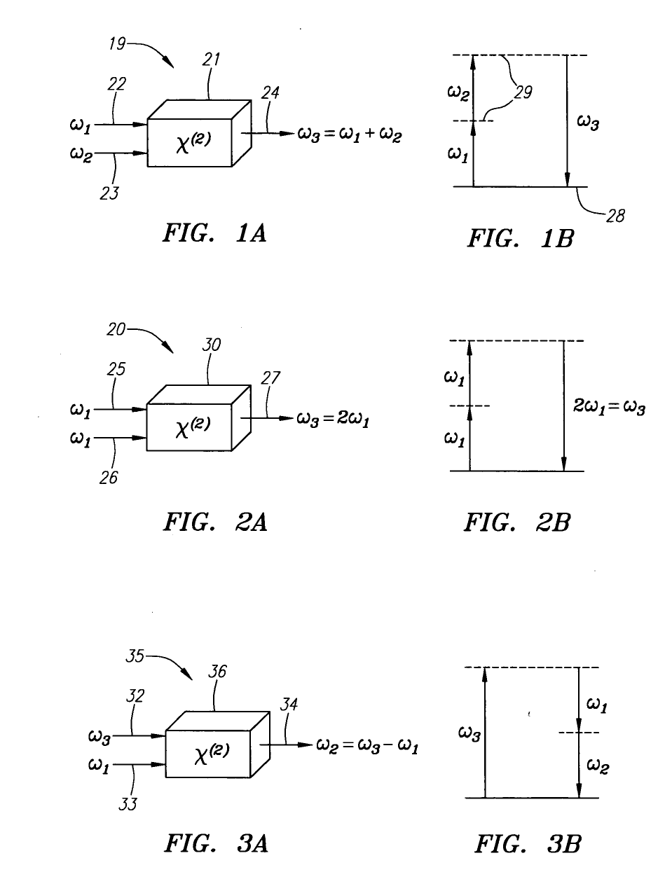

Four nonlinear optical devices according to the present invention are illustrated schematically in FIGS. 1-4.

FIG. 1A is a schematic illustration of a nonlinear optical device 19 according to the present invention. Nonlinear optical device 19 is a frequency adder that employs sum-frequency generation. Sum-frequency generation may be thought of as a welding process in which two photons are welded together to produce a single photon with the combined energy of both original photons. The nonlinear optical device 19 comprises nonlinear optical medium 21. Nonlinear optical medium 21 comprises a nonlinear optical grating, such as nonlinear optical grating 60 shown in FIG. 6, which in the present embodiment is configured to carry out the sum-frequency generation process for three interacting light waves having frequencies ω₁, ω₂ and ω₃. As seen in FIG. 1A, input waves 22, 23 of light at frequencies ω₁, ω₂, respectively, enter nonlinear optical medium 21 and interact to produce an output wave 24 at the sum frequency ω₃=ω₁+ω₂. FIG. 1B is a photon energy-level diagram schematically describing the conservation of energy that occurs in the sum-frequency generation process, and shows that two photons of frequency ω₁, ω₂ are consumed for each photon of frequency ω₃ produced through the sum-frequency generation process. Thus, the two photons of lower input frequency ω₁, ω₂, are destroyed and a photon of higher output frequency ω₃ is simultaneously created in a single quantum-mechanical process. The solid line 28 in FIG. 1B represents the atomic ground state, and the dashed lines 29 represent what are known as virtual levels.

FIG. 2A is a schematic illustration of a nonlinear optical device 20 according to the present invention. Nonlinear optical device 20 is a frequency doubler that employs second-harmonic generation. Second-harmonic generation or frequency doubling is one of the most commonly-used frequency-mixing processes and can be viewed as a special case of sum-frequency generation, namely the case in which the frequencies of the two input waves are the same.

The nonlinear optical device 20 comprises nonlinear optical medium 30. Nonlinear optical medium 30 comprises a nonlinear optical grating, such as nonlinear optical grating 60 shown in FIG. 6, which in the present embodiment is configured to carry out the second-harmonic generation process for light waves having frequencies ω₁ and ω₃. As seen in FIG. 1A, input waves 25, 26 of light at frequency ω₁ enter nonlinear optical medium 30 and interact to produce an output wave 27 at the sum frequency ω₃=2ω₁. FIG. 2B is a photon energy-level diagram schematically describing the conservation of energy that occurs in second-harmonic generation, and shows that two photons of frequency ω₁ are consumed for each photon of frequency ω₃=2ω₁ produced through the second-harmonic generation process. One common use of second-harmonic generation is to convert the output of a fixed frequency laser to a different spectral region. For example, second-harmonic generation can be used to convert input waves 25, 26 of light having a wavelength about twice that of visible light, such as from an Nd:YAG laser, to an output wave 27 of light having a wavelength in the visible spectrum.

FIG. 3A is a schematic illustration of a nonlinear optical device 35 according to the present invention. Nonlinear optical device 35 is a frequency subtractor that employs difference-frequency generation or parametric amplification. The nonlinear optical device 35 comprises nonlinear optical medium 36. Nonlinear optical medium 36 comprises a nonlinear optical grating, such as nonlinear optical grating 60 shown in FIG. 6, which in the present embodiment is configured to carry out difference-frequency generation for three interacting light waves having frequencies ω₁, ω₂ and ω₃. As seen from FIG. 3A, input waves 32, 33 of light at frequencies ω₃ and ω₁, respectively, interact in nonlinear optical medium 36 to produce an output wave at the difference frequency ω₂=ω₃−ω₁. By reviewing the photon energy-level diagram of FIG. 3B it is observed, however, that in the difference-frequency generation process that conservation of energy requires that for each photon produced at the difference frequency ω₂=ω₃−ω₁, a photon at the higher input frequency (ω₃) must be destroyed and a photon at the lower input frequency (ω₁) must be created. In other words, the lower input frequency (ω₁) is amplified, which is why difference-frequency generation is also known as parametric amplification.

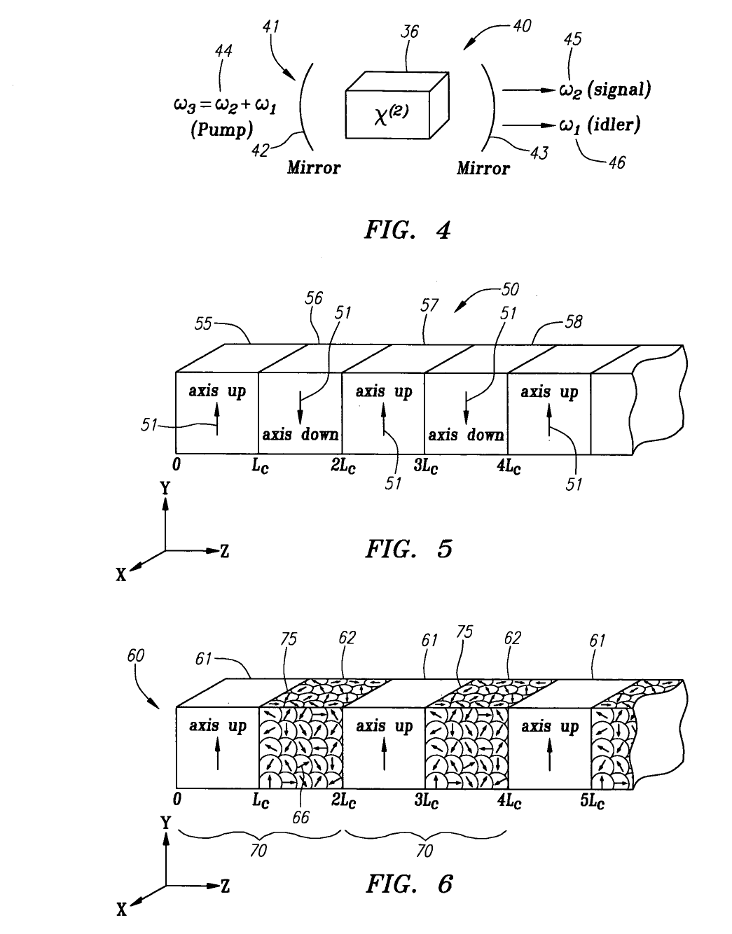

FIG. 4A is a schematic illustration of a nonlinear optical device 40 according to the present invention. Nonlinear optical device 40 is an optical parametric oscillator. The nonlinear optical device 40 comprises nonlinear optical medium 36 defining a nonlinear optical grating, such as nonlinear optical grating 60 shown in FIG. 6, which is configured to carry out difference-frequency generation for three interacting light waves having frequencies ω₁, ω₂ and ω₃. As illustrated by FIG. 3B, in the process of difference-frequency generation, the presence of light at frequency ω₁ or ω₂ can cause the emission of additional photons at these frequencies. Accordingly, by placing nonlinear optical medium 36 inside an optical resonator 41, such as a that formed by the pair of mirrors 42, 43, the ω₁ and/or ω₂ fields can build up to large values. Optical parametric oscillators are tunable because any frequency ω₁ less than ω₃ can satisfy the condition ω₂+ω₁=ω₃. In practice, however, the output frequency of an optical parametric oscillator 40 is controlled by adjusting the phase-matching condition of the nonlinear optical medium 36 as discussed more fully below. As with conventional optical parametric oscillators, the applied field frequency ω₃ is called the pump frequency 44, the desired output frequency, ω₂, is called the signal frequency 45, and the other output frequency, ω₁, is called idler frequency 46.

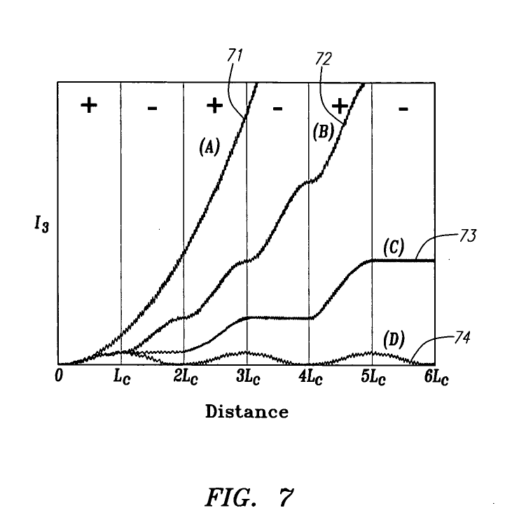

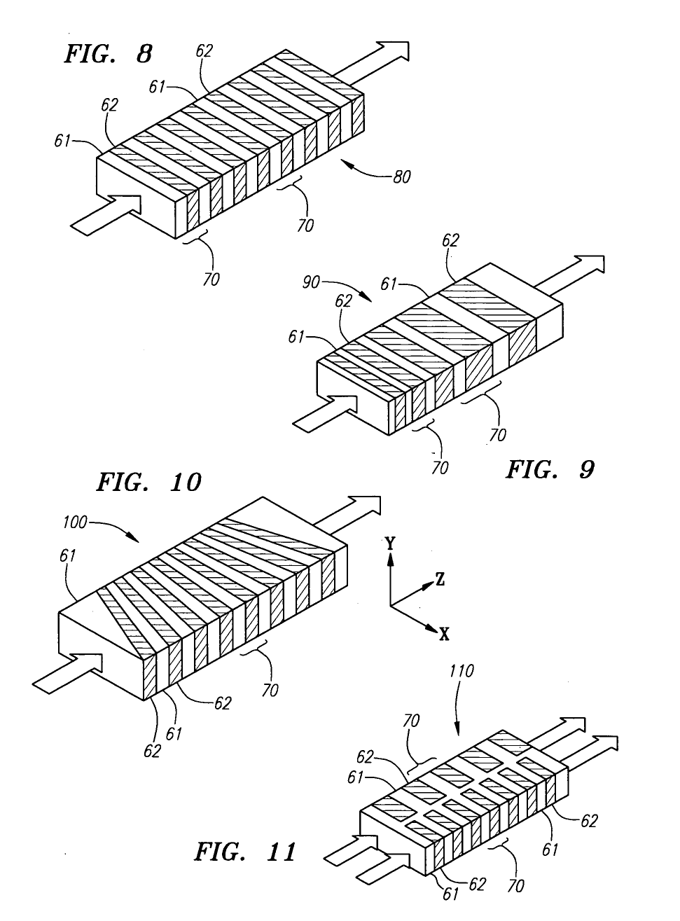

FIG. 5 is a schematic view of a prior art single crystal 50 of a periodically-poled nonlinear optical material for achieving quasi-phase-matching. Single crystal 50 has been periodically-poled so that the orientation of the crystalline axis 51, along the y-axis of the crystal, is inverted after every length L_{c}, corresponding to the coherence length, along the z-axis. Thus, the first segment 55 of single crystal 50 having a length L_{c} has its crystalline axis 51 up, the second segment 56 of single crystal 50 having a length L_{c} (for a total length 2L_{c}) has its crystalline axis 51 down, the third segment 57 of single crystal 50 having a length L_{c} (for a total length 3L_{c}) has its crystalline axis 51 up, the forth segment 58 of single crystal 50 having a length L_{c} (for a total length 4L_{c}) has its crystalline axis 51 down, and so on. An inversion of the crystalline axis leads to an inversion of the sign of the nonlinear coupling coefficient d_{eff}. Thus the periodic inversion of the nonlinear coupling coefficient every length L_{c} will compensate for the phase mismatch resulting from dispersion so that power will continue to flow from input waves to output waves, in the case of sum-generation, for example. As a result, the intensity I₃ of the output wave will increase as shown in curve (B) of FIG. 7. A detailed description of the quasi-phase-matching technique can be found in R. Boyd, Nonlinear Optics, Second Edition at pp. 107-111 (2003).

FIG. 6 shows a schematic view of a nonlinear optical grating 60 according to one embodiment of the present invention. Nonlinear optical grating 60 provides a new technique for achieving a modified type of quasi-phase-matching in a nonlinear optical medium, such as nonlinear optical mediums 21, 30, and 36 used in the nonlinear optical devices described above.

Nonlinear optical grating 60 comprises a plurality of adjacent nonlinear optical (NLO) units 70 disposed in series with one another. Each NLO unit 70 comprises a single crystal segment 61 and a polycrystalline segment 62. Preferably the single crystal segment 61 of each NLO unit 70 is formed from a single crystal of a nonlinear optical material and has its crystalline axis oriented in the same direction along the y-axis, such as up. However, when the single crystal segment is formed from a cubic crystalline material, it is unnecessary to orient the crystalline axis of each single crystal segment 61 in the same direction in the gratings of the present invention.

The single crystal segment 61 of each NLO unit 70 has a length adapted to provide a desired nonlinear optical effect, such as sum-frequency generation, second-harmonic generation, or difference-frequency generation. Further, the polycrystalline segment 62 of each NLO unit 70 has a length adapted to compensate for phase mismatch that occurs in the single crystal segment 61 of its NLO unit. In the embodiment illustrated in FIG. 6, each of the single crystal segments 61 and each of the polycrystalline segments 62 have a length corresponding to the coherence length, L_{c}, for the desired nonlinear optical interaction. Thus, each NLO unit 70 included in the grating 60 of the illustrated embodiment has a length equal to 2L_{c}. As will be described in more detail below, however, other lengths for the single crystal segments 61, polycrystalline segments 62, and NLO units 70 are possible.

Thus, instead of periodically poling the y-axis of a nonlinear crystal, such as in the case of periodically-poled single crystal 50 shown in FIG. 5 to achieve phase-matching, in the nonlinear optical grating 60 of the present invention a periodic chain of alternating single crystal segments 61 and polycrystalline segments 62 is provided. The single crystal segments 61 and polycrystalline segments 62 are preferably made from the same nonlinear optical material and in one embodiment have the same length corresponding to the coherence length, L_{c}, for a desired nonlinear optical interaction.

Depending on the symmetry of the arrangement of the atoms on the crystal lattice (e.g. cubic, triclinic, tetragonal, etc.), it is intuitively clear that the index of refraction, n, in crystalline solids can be a function of the direction of propagation of light in relation to the crystal axes. Cubic crystals, however, are isotropic in the first order in that the refractive index n (or the related parameter χ⁽¹⁾, the first order or linear susceptibility) is isotropic, i.e. independent of the direction of propagation of light relative to the crystal axes. At the same time, material can posses a cubic lattice and yet be noncentrosymmetric (e.g. GaAs, InP, etc. as opposed to Si, Ge, . . . which are centrosymmetric). Noncentrosymmetric cubic crystals have a nonlinear dielectric response to light, and thus possess a second order susceptibility tensor χ⁽²⁾ in the polarization response of the crystal. It is this term that is responsible for nonlinear interactions of the second order. Accordingly, the single crystal segments 61 are preferably formed from a nonlinear optical material that has a cubic crystal structure, and hence has an isotropic refractive index. More preferably, single crystal segments 61 comprise a noncentrosymetric cubic crystal. Noncentrosymetric cubic crystal materials include III-V and II-VI compounds.

The polycrystalline segments 62 are preferably formed from the same nonlinear optical material as the single crystal segments 61. This is desirable for several reasons. First, the individual crystal grains 66 of the polycrystalline segments 62 will have their axes randomly oriented, but if such grains are formed from cubic crystals, the refractive index of polycrystalline segments 62 will be the same as that of single crystal segments 61. Hence the passage of the input and output waves through a length L_{c} of polycrystalline material will achieve the goal of causing a phase change of π, and thus bring back the condition of power flow from input wave(s) to the output wave(s) (e.g., from input waves 25, 26 to output wave 27 in the case of sum-frequency generation) in the succeeding single crystal segment of length L_{c}. Second, by using the same material for the polycrystalline segments 62 and single crystal segments 61, undesirable reflections are avoided at the interfaces 75 between the single crystal segments 61 and polycrystalline segments 62. Using different materials for the single crystal segments 61 and polycrystalline segments 62 may lead to reflections at interfaces 75 for one or more of the frequencies of light involved in the nonlinear interaction unless the refractive index of both materials is the same at each of the frequencies of light involved in the interaction. This is because any time light travels from one medium to another medium having a different refractive index a portion of the light will be reflected at the interface. Further, the greater the difference in refractive indices, the greater the reflection loss at each interface. And, while the amount of light reflected at any given interface 75 may be small, when it is considered that there will typically be hundreds or thousands of such interfaces in a desired grating 60, the cumulative loss of light may become unacceptable. Third, by using the same material for both the single crystal segments 61 and the polycrystalline segments, the overall construction of the device is simplified because the coherence length, L_{c}, in both the single crystal segments and polycrystalline segments will be the same and because both segments can be simultaneously grown on a suitable substrate using standard crystal growth techniques.

Assuming unacceptable losses are not created for a particular application, however, polycrystalline segments 62 may be formed from a material other than the nonlinear optical material used to form the single crystal segments, such as a centrosymetric cubic material or an amorphous material. Further, it should be noted that by careful matching of refractive indices between the materials, the reflection losses at interfaces 75 may be minimized or even eliminated for one or more of the interacting waves.

The nonlinear optical devices described herein are based on the realization that polycrystalline segments 62 can be used to substitute for the periodic inversion of the crystalline axis in a grating formed by a periodically-poled nonlinear optical single crystal to achieve quasi-phase-matching. Further, as described more fully below, the nonlinear optical grating 60 may be readily formed using standard lithographic and crystal growth technologies from a much wider variety of materials than may be used to form conventional periodically-poled single nonlinear crystals. In the polycrystalline segments 62 of the gratings according to the present invention, however, there is no or minimal coherent exchange of energy between the interacting frequencies and thus the polycrystalline segments 62 act as a neutral material or almost neutral material as far as the nonlinear interaction is concerned. Hence the intensity of the output wave for the sum-generation process, for example, may increase at up to half the average rate as that of a conventional periodically-poled crystal as the interacting waves travel along the z-axis of the nonlinear optical grating 60 as shown in curve (C) of FIG. 7.

For illustration purposes, the theoretical intensity generated by a nonlinear optical grating 60 adapted for sum-frequency generation is now reviewed. Based on R. Boyd's book, Nonlinear Optics, Second Edition at p. 75, it is known that for the sum-frequency generation process in a single nonlinear crystal

I₃=(512π⁵d_{eff}²I₁I₂/n₁n₂n₃λ₃²c)L² sinc²(ΔkL/2) (1)

where I₁, I₂ and I₃ are the intensities of light at frequencies ω₁, ω₂ and ω₃ of input waves 22, 23 and output wave 27, respectively; n₁, n₂ and n₃ are the refractive indices of the nonlinear optical material at wavelengths λ₁, λ₂ and λ₃ (corresponding to frequencies ω₁, ω₂ and ω₃), respectively; d_{eff} is the nonlinear coupling coefficient and is related to the nonlinear susceptibility tensor χ⁽²⁾; c is the velocity of light in vacuum; L is the length of the crystal; and the effect of wave vector mismatch is included entirely in the factor Δk. The factor Δk is a phase mismatch factor equal to k₃−k₁−k₂, where k₁, k₂ and k₃ correspond to wave vectors for each light wave interacting nonlinearly and k₁=n₁ω₁/c, k₂=n₂ω₂/c and k₃=n₃ω₃/c. By convention, ω₃ is always the frequency of the highest frequency light wave involved in the nonlinear optical interaction, regardless of whether the nonlinear optical interaction comprises sum-frequency generation, second-harmonic generation, or difference-frequency generation, and hence k₃ always corresponds to the wave vector for the light wave with the greatest frequency of light.

For the special case of Δk=0, the term sinc²(ΔkL/2), which can be written as sin²(ΔkL/2)/(ΔkL/2)², becomes 1. Therefore, the output intensity of the sum-frequency wave I₃ increases with L in a quadratic manner. This condition is known as the perfect phase matching condition and is shown in curve (A) of FIG. 7. Because crystals have dispersion, the refractive indices of the interacting frequencies are not equal (n₁≠n₂≠n₃), hence, Δk≠zero. For situations where Δk does not equal zero, sinc²(Δk L/2) is oscillatory with respect to L as seen in curve (D) of FIG. 7. As L increases, say along the z-axis, output wave 27 having intensity I₃ gets out of phase with the driving polarization induced by input waves 25, 26 having intensities I₁ and I₂, respectively. At L=L_{c} the output wave is π out of phase with its driving polarization. As a result, once L increases beyond a length L_{c}, power starts flowing back from output wave 27 (I₃) to inputs waves 25, 26 (I₁ and I₂) until L reaches 2L_{c} where the power of output wave 27 (I₃) is zero and the output wave is 2π out of phase with its driving polarization. At that point the interacting waves are no longer out of phase and the cycle repeats itself for greater lengths of L. This oscillating phase mismatch condition is shown in curve (D) of FIG. 7. The length L_{c}=π/Δk is called the coherence length.

Referring to polycrystalline segments 62, when individual crystal grains in a polycrystalline material are randomly oriented, there is a random change of crystal axes direction as light moves from one grain to a neighboring grain. As a result, the phase relationships among the interacting light waves start all over from zero at each new grain boundary, although not necessarily in coherence with the interactions in the previous grain(s) or the previous single crystal segment. This makes the nonlinear interactions occurring in the different grains of polycrystalline segment 62 independent of one another. In other words, the nonlinear interactions that occur in polycrystalline segment 62 are noncoherent.

As demonstrated below, when the average grain size in the polycrystalline segments 62 is g then the loss of intensity in I₁ and I₂ to generate I₃ will be proportional to g/L_{c}. EQU. 1 can be rewritten as I₃=A L² sinc²(Δk L/2), where A=(512π₅d_{eff}² I₁I₂)/(n₁n₂ n₃λ₃²c). Thus, applying this equation to a polycrystalline grain of length g, I₃^{g}=A g² sinc² (Δk g/2)=A g² sin²(Δk g/2)/(Δk g/2)₂.

### For very small g, where g/L_{c}≦10⁻²,

sin²(Δkg/2)≈(Δkg/2)²

hence, I₃^{g}=A g².

In a polycrystalline segment of length L_{c}, the average number of grains of length g is L_{c}/g. Because each grain will be acting independently (incoherently), total intensity I₃^{poly} generated in this polycrystalline segment of length L_{c} will be

I₃^{poly}=I₃^{g}L_{c}/g=Ag²L_{c}/g=AL_{c}g (2)

### This value may now be compared with the intensity generated by a single crystal having a length corresponding to the coherent length, L_{c}. The intensity I₃^{sc} generated in a single crystal with length L_{c}=π/Δk is

$$\begin{matrix}{I}_{3}^{sc} = A {L}_{c}^{2} sin {c}^{2} ( Δ k {L}_{c} / 2 ) \\ = A {L}_{c}^{2} sin {c}^{2} ( ( π / Δ k ) ( Δ k / 2 ) ) \\ = A {L}_{c}^{2} sin {c}^{2} ( π / 2 ) \\ = A {L}_{c}^{2} {sin}^{2} ( π / 2 ) / {( π / 2 )}^{2} \\ = ( 4 / {π}^{2} ) A {L}_{c}^{2} .\end{matrix} \qquad ( 3 )$$

From EQU. 2 and EQU. 3, the ratio I₃^{poly}/I₃^{sc} can be defined as follows:

I₃^{poly}/I₃^{sc}=AL_{c}g/((4/π²)AL_{c}²)=(π²/4)=(g/L_{c})

This ratio is proportional to g/L_{c} and thus can be made insignificantly small by proper growth techniques. There is also excellent experimental proof for this in a very early paper “A powder technique for the evaluation of nonlinear optical materials” by S. K. Kurtz and T. T. Perry, pp. 3798-3813, Journal of Applied Physics, vol. 39, no. 8 (July 1968). There, the authors studied second harmonic generation in powdered crystalline material, which mimics a polycrystalline material, and found that the second harmonic intensity of the powder was proportional to g/L_{c} for g<L_{c}. Further experimental proof that as g/L_{c} tends toward zero the efficiency of the nonlinear reaction in a polycrystalline material tends toward zero may be found in M. Buadrier-Raybaout, et al., Random Quasi-phase-matching in Bulk Polycrystalline Isotropic Nonlinear Materials, Nature, vol. 432, 374-76 (Nov. 18, 2004).

With modern growth techniques it is possible to control the grain size, g, of the individual grains 66 forming the polycrystalline segments 62 to be in the range of g/L_{c} of 10⁻² or less. Further, the polycrystalline segments 62 are preferably formed so that grains 63 are randomly oriented so that on average there is no or little coherent exchange of energy between the input and output waves. As a result, the polycrystalline segments 62 should achieve the phase change necessary but act as a neutral or almost neutral material as far as the nonlinear interactions are concerned. Hence the growth of intensity, I₃, for the output wave 27 with successive passage through the periodic chain of NLO units 70 forming the grating 60 should look like curve (C) in FIG. 7. One can notice from curve (C) of FIG. 7 that between 0 and L_{c}, the line is overlapping with line (B) of the conventional quasi-phase-matching curve for a periodically-poled single crystal of a nonlinear optical material. Between L_{c} and 2L_{c}, curve (C) goes flat, or almost flat, because in the polycrystalline segment 62 there is negligible coherent nonlinear interaction until the next single crystal segment 61 that is between 2L_{c} and 3L_{c} where energy is again transferred to the output wave 27 and adds up constructively with the propagation distance. This cycle repeats itself as the interacting waves continue to propagate through the grating 60. As seen from FIG. 7, a length L of grating 60 according to the present embodiment of the invention will produce the same output intensity I₃ as a periodically-poled quasi-phase-matched single crystal 50 of length L/2.

While it is preferable for the average grain size in the polycrystalline segments 62 to be sufficiently small so that the ratio g/L_{c} is equal to or less than 10⁻², larger average grain sizes may also be used. For example, average grain sizes that result in a ratio g/L_{c} greater than or equal to 10⁻² but less than or equal to 10⁻¹ in polycrysalline segments 62 will also work, but with a somewhat lower efficiency for the coherent generation of I₃. The multiple interactions of the light waves with the numerous randomnly oriented grains, both along and across the cross section of the polycrystalline segment 62 will ensure that the interactions are non-coherent with what occurred in the previous single crystal segment 61, thus avoiding the loss of light from I₃ to I₁ and I₂. As will be appreciated from the equation, I₃^{g}=A g² sinc²(Δk g/2), in each grain a certain small amount of I₃ will be generated at the expense of I₁ and I₂, but in an incoherent fashion. Hence poly crystalline segment 62, besides achieving the phase change necessary for the continuation of the coherent interaction of converting I₁ and I₂ to I₃ in the succeeding single crystal segment 61, will generate a small amount of incoherent I₃ (with an equal amount of loss of I₁ and I₂). As a result, the portions of curve C in FIG. 7 corresponding to the polycrystalline segments 62 will show a small amount of upward slope, instead of being flat, as the average grain size increases above about g/L_{c} equal to 10⁻². Further, the slope should continue to increase slightly as the average grain size continues to increase. However, as the contribution to I₃ will be incoherent to that generated in the single crystal segments, the generation of this I₃ will create an inefficiency in the mixing process carried out in the grating 60. The average grain size in the polycrystalline segments 62 should be maintained so that the ratio g/L_{c} does not exceed about 10⁻¹. These larger grain sizes are undesirable because the number of grains in the polycrystalline segment are reduced to the point that I₃ generated in the polycrystalline segment may be generated that is coherent with the I₃ generated in the preceeding single crystal segment, yet be out of phase, thus causing power to flow from the coherent output wave 27 to input waves 25, 26. This will be appreciated from the fact that when g equals L_{c} the situation in curve D of FIG. 7 will exist.

While the foregoing discussion has focused on sum-frequency generation, grating 60 may also be used for second-harmonic generation and difference-frequency generation by appropriately setting the lengths of the single crystal segments 61 and polycrystalline segments to achieve the desired degree of phase-matching. In this regard, it is noted the illustrated embodiment of nonlinear optical grating 60 shown in FIG. 6 has an optimal configuration in that the single crystal segments 61 and the polycrystalline segments 62 have a length corresponding to the coherence length L_{c} corresponding to the desired optical interaction so that each NLO unit 70 has a length of 2L_{c}. With this configuration the efficiency of the desired nonlinear optical process will be optimized. However, a variety of deviations may be made from this optimal configuration without departing from the present invention; some of the presently contemplated deviations are discussed below.

In one embodiment, for example, each NLO unit 70 is set to have a length substantially equal to nL_{c} where n is an even number and L_{c} is the coherent length for the nonlinear optical interaction for which the grating has been designed. In this embodiment, the specific lengths of the single crystal segment 61 and the polycrystalline segment 62 in the NLO unit is not specified. This is because power will be transferred to the output wave in an NLO unit 70 so long as the single crystal segment 61 of the NLO unit has a length equal to xL_{c} and the polycrystalline segment 62 has a length equal to yL_{c}, where x and y are odd numbers or fractional numbers and combine to form an NLO unit of substantially equal to nL_{c} where n is an even number. The term “substantially” as used herein is intended to recognize that slight variations in the manufacturing process might preclude the desired nominal length from being achieved with absolute accuracy, but also that some variation in the stated lengths are acceptable because curve (D) of FIG. 7 tends to gradually change around the alternating maximum and minimum values associated with the different multiples of the coherent length, L_{c}. Thus, when lengths are expressed herein as being substantially equal to some multiple of the coherent length, L_{c}, it is to be understood that a value within ±20% of L_{c} for the stated value are contemplated. Thus in a preferred embodiment, the single crystal segment 61 of each NLO unit 70 preferably has a length substantially equal to xL_{c}, the polycrystalline segment 62 preferably has a length substantially equal to yL_{c}, and the total length of each NLO unit 70 is preferably substantially equal to nL_{c}, where x and y are odd numbers and n is an even number. In yet another embodiment, the single crystal segment 61 of each NLO unit 70 is set to have a length equal to xL_{c}, the polycrystalline segment 62 of each NLO unit 70 is set to have a length equal to yL_{c}, and the total length of each NLO unit is substantially equal to nL_{c}, where x and y are odd numbers or fractional numbers and n is an even number. Ideally x and y in the foregoing embodiments equal 1 so that the single crystal segment and polycrystalline segment have approximately the same length and n equals 2.

Further, while each of the NLO units 70 of grating 60 have substantially the same length, so as to form a uniform grating, such as uniform grating 80 shown in FIG. 8, in other embodiments, such as in the chirped grating 90, at least two of the NLO units 70 have different lengths. In addition, it is also possible for the length of each of the single crystal segments 61 and polycrystalline segments 62 to vary from one side of the nonlinear optical grating to the other side of the nonlinear optical grating as illustrated in the fan-out nonlinear optical grating 100 shown in FIG. 10. The fan-out grating 100 shown in FIG. 10 may be advantageously used in a variety of nonlinear optical interactions as it allows the process to be tuned by traversing the input wave(s) across the face of the grating 100 until the desired phase-matching conditions are achieved for a particular nonlinear optical interaction. This property may, in particular, be used advantageously in parametric oscillators where a tunable signal frequency is desired.

In yet a further embodiment of the invention, the nonlinear optical device may further comprise a second nonlinear optical grating. The second grating may be disposed adjacent the first grating in a side-by-side relationship, such as illustrated in the multiple grating 110 shown in FIG. 11, or disposed in series with the first grating. Thus, a nonlinear optical device according to the present invention may comprise a uniform grating 80 disposed in series with a chirped grating 90 or a fan-out grating 100.

As will be apparent from the foregoing description, the nonlinear optical gratings according to the present invention may be used to form a variety of nonlinear optical devices, including, for example, frequency doublers, frequency adders, frequency subtractors, amplifiers, and parametric oscillators. Moreover, the nonlinear optical gratings may form the core of a waveguide, preferably a single mode waveguide.

According to another aspect, a method for forming a nonlinear optical device adapted to provide a nonlinear optical effect is provided. The method comprises forming a first nonlinear optical grating, such as grating 60, comprising a plurality of NLO units 70 disposed in series, wherein each NLO unit comprises a single crystal segment 61 and a polycrystalline segment 62, the single crystal segment 61 comprises a single crystal of a nonlinear optical material having a length adapted to provide a nonlinear effect, and the polycrystalline segment 62 has a length adapted to compensate for phase mismatch occurring in the single crystal segment.

Preferably each of the NLO units 70 are formed to have a length substantially equal to nL_{c} where n is an even number and L_{c} is the coherent length for the nonlinear optical interaction for which the NLO medium has been designed. Further, while the NLO units 70 are preferably formed to have substantially the same length, they may also have different lengths. More preferably, the single crystal segment 61 of each NLO unit 70 is formed to have a length substantially equal to xL_{c}, the polycrystalline segment 62 is formed to have a length substantially equal to yL_{c}, and the total length of each NLO unit 70 is substantially equal to nL_{c}, where x and y are odd numbers and n is an even number. In an alternative embodiment, the single crystal segment 61 of each NLO unit 70 is formed to have a length equal to xL_{c}, the polycrystalline segment 62 is formed to have a length equal to yL_{c}, and the total length of each NLO unit is substantially equal to nL_{c}, where x and y are odd numbers or fractional numbers and n is an even number. Ideally x and y in the foregoing embodiments equal 1 so that the single crystal segment and polycrystalline segment have approximately the same length and n equals 2. Moreover, the single crystal segment preferably formed from a cubic crystal, and more preferably a noncentrosymmetric, cubic crystal. The polycrystalline segment is preferably formed from the same material as that of said single crystal segment.

The method according to the present aspect of the invention may further comprise the step of forming a second nonlinear optical grating. The second grating may be adjacent the first grating in a side-by-side relationship or disposed in series with the first grating. Further, the nonlinear optical gratings may comprise, for example, a grating selected from the group consisting of a uniform grating, a fan-out grating, and a chirped grating.

At least two methods are available for forming a nonlinear optical grating, such as grating 60, used in the nonlinear optical devices according to the present invention. In one method, for example, a single crystal nonlinear optical material of a desired length and width may be grown using conventional crystal growth techniques on top of a substrate of the corresponding nonlinear optical material. Thus, for example, if the substrate is GaAs, the grown crystal is also preferably GaAs.

After the single crystal of desired length and width is grown, then the crystal is masked and then etched to form a plurality single crystal segments each having a length, such as L_{c}. The etching forms a gap between each of the successive single crystal segments corresponding to the desired size of the interposed polycrystalline segment. For example, in one embodiment the single crystal segments are each spaced apart by a distance of about L_{c}, but as those skilled in the art will appreciate from the disclosure above, other spacing may be desirable depending on the desired characteristics of the nonlinear optical grating to be fabricated. The single crystal segments may then be masked and the polycrystalline segments are grown preferably from the same material from which the single crystal segments are formed. Advantageously, all of the polycrystalline segments may be grown simultaneously.

In a second, alternative method, for forming the nonlinear optical gratings according to the present invention, a substrate of the desired nonlinear optical material, such as a substrate of III-V or II-VI compound, is obtained. A thin seed layer of polycrystalline SiO₂ or some other suitable polycrystalline material, such as a polycrystalline dielectric, is then formed on the surface of the substrate. The seed layer is then masked with a suitable positive or negative mask, after which the mask layer is exposed and developed to remove the masking from those areas where the single crystal segments will be formed. The masked substrate is then etched to remove the seed layer from the unmasked regions until the underlying crystalline substrate is exposed, thereby forming a patterned wafer. Crystals are then grown on top of the patterned wafer. In those areas where the polycrystalline SiO₂ seed layer remains, a polycrystalline segment is formed. In those areas that had been etched a single crystal segment is grown. Thus, by appropriately defining the mask, any of the gratings described may be formed. Preferably the crystal segments and polycrystalline segments are grown from the same III-V or II-VI compound (e.g., GaAs) as used for the substrate.

Although the nonlinear optical grating 60 has length in the z-axis direction, when the grating is grown, it is more convenient to grow the grating in the x-axis direction or the y-axis direction.

While the nonlinear optical grating described herein are preferably configured to support a second-order nonlinear optical interaction, the nonlinear optical gratings may also be readily configured to support higher order nonlinear interactions, including, for example, third and fourth-order interactions. Further, while various embodiments of a nonlinear optical device and methods of making a nonlinear optical device have been described herein, numerous modifications, alterations, alternate embodiments, and alternate materials may be contemplated by those skilled in the art and may be utilized in accomplishing the various aspects of the present invention. It is envisioned that all such alternate embodiments are considered to be within the scope of the present invention as described by the appended claims.

What is claimed is:

1. A nonlinear optical device comprising a first grating, the first grating having a plurality of adjacent NLO units disposed in series to one another, each NLO unit comprising a single crystal segment and a polycrystalline segment, the single crystal segment comprising a single crystal of a nonlinear optical material having a length adapted to provide a nonlinear effect and the polycrystalline segment having a length adapted to compensate for phase mismatch.

2. A nonlinear optical device according to claim 1, wherein each NLO unit has a length substantially equal to nL_{c} where n is an even number.

3. A nonlinear optical device to claim 2, wherein each NLO unit has substantially the same length.

4. A nonlinear optical device according to claim 2, wherein at least two NLO units have different lengths.

5. A nonlinear optical device according to claim 1, wherein the single crystal segment has a length substantially equal to xL_{c}, the polycrystalline segment has a length substantially equal to yL_{c}, and the total length of each NLO unit is substantially equal to nL_{c}, where x and y are odd numbers and n is an even number.

6. A nonlinear optical device according to claim 5, wherein each NLO unit has substantially the same length.

7. A nonlinear optical device according to claim 5, wherein at least two NLO units have different lengths.

8. A nonlinear optical device according to claim 5, wherein x and y equal 1 and n equals 2.

9. A nonlinear optical device according to claim 5, wherein the single crystal segment and polycrystalline segment have approximately the same length.

10. A nonlinear optical device according to claim 5, wherein L_{c} is set equal to π/|Δk|, where Δk is a phase mismatch factor equal to k₃−k₁−k₂, where k₁=n₁ω₁/c, k₂=n₂ω₂/c and k₃=n₃ω₃/c, and where ω₁, ω₂, and ω₃ correspond to the frequency of each light wave involved in the nonlinear interaction, ω₃ is the frequency of the highest frequency light wave involved in the interaction, and n₁, n₂, and n₃ equal the refractive index of the nonlinear optical material at frequencies ω₁, ω₂, and ω₃, respectively.

11. A nonlinear optical device according to claim 1, wherein the single crystal segment has a length equal to xL_{c}, the polycrystalline segment has a length equal to yL_{c}, and the total length of each NLO unit is substantially equal to nL_{c}, where x and y are odd numbers or fractional numbers and n is an even number.

12. A nonlinear optical device according to claim 1, wherein said single crystal is a cubic crystal.

13. A nonlinear optical device according to claim 12, wherein said single crystal is noncentrosymmetric.

14. A nonlinear optical device according to claim 12, wherein the polycrystalline segment is formed from the same nonlinear optical material as that of the single crystal segment.

15. A nonlinear optical device according to claim 1, wherein the first grating is adapted to define a waveguide core.

16. A nonlinear optical device according to claim 1, further comprising a second nonlinear optical grating.

17. A nonlinear optical device according to claim 16, wherein the second nonlinear optical grating is adjacent the first grating in a side-by-side relationship.

18. A nonlinear optical device according to claim 16, wherein the second grating is disposed in series with the first grating.

19. A nonlinear optical device according to claim 1, wherein the first grating comprises a grating selected from the group consisting of a uniform grating, a fan-out grating, and a chirped grating.

20. A nonlinear optical device comprising a first nonlinear optical grating, the first grating having a plurality of adjacent NLO units disposed in series to one another, each NLO unit comprising a single crystal segment and a polycrystalline segment, the single crystal segment comprising a single crystal of a cubic, noncentrosymmetric nonlinear optical material having a length adapted to provide a nonlinear effect, and the polycrystalline segment comprising the same nonlinear optical material as the single crystal segment and having a length that compensates for phase mismatch occurring in the single crystal segment.

21. A nonlinear optical device according to claim 20, wherein each NLO unit has a length substantially equal to nL_{c} where n is an even number.

22. A nonlinear optical device to claim 21, wherein each NLO unit has substantially the same length.

23. A nonlinear optical device according to claim 21, wherein at least two NLO units have different lengths.

24. A nonlinear optical device according to claim 20, wherein the single crystal segment has a length substantially equal to xL_{c}, the polycrystalline segment has a length substantially equal to yL_{c}, and the total length of each NLO unit is substantially equal to nL_{c}, where x and y are odd numbers and n is an even number.

25. A nonlinear optical device according to claim 24, wherein each NLO unit has substantially the same length.

26. A nonlinear optical device according to claim 24, wherein at least two NLO units have different lengths.

27. A nonlinear optical device according to claim 24, wherein x and y equal 1 and n equals 2.

28. A nonlinear optical device according to claim 24, wherein the single crystal segment and polycrystalline segment have approximately the same length.

29. A nonlinear optical device according to claim 24, wherein L_{c} is set equal to π/|Δk|, where Δk is a phase mismatch factor equal to k₃−k₁−k₂, where k₁=n₁ω₁/c, k₂=n₂ω₂/c and k₃=n₃ω₃/c, and where ω₁, ω₂, and ω₃ correspond to the frequency of each light wave involved in the nonlinear interaction, ω₃ is the frequency of the highest frequency light wave involved in the interaction, and n₁, n₂, and n₃ equal the refractive index of the nonlinear optical material at frequencies ω₁, ω₂, and ω₃, respectively.

30. A nonlinear optical device according to claim 20, wherein the single crystal segment has a length equal to xL_{c}, the polycrystalline segment has a length equal to yL_{c}, and the total length of each NLO unit is substantially equal to nL_{c}, where x and y are odd numbers or fractional numbers and n is an even number.

31. A nonlinear optical device according to claim 20, wherein the first grating is adapted to define a waveguide core.

32. A nonlinear optical device according to claim 20, further comprising a second nonlinear optical grating.

33. A nonlinear optical device according to claim 32, wherein the second nonlinear optical grating is adjacent the first grating in a side-by-side relationship.

34. A nonlinear optical device according to claim 32, wherein the second grating is disposed in series with the first grating.

35. A nonlinear optical device according to claim 20, wherein the first grating comprises a grating selected from the group consisting of a uniform grating, a fan-out grating, and a chirped grating.

36. A method for forming a nonlinear optical device adapted to provide a nonlinear optical effect, the method comprising:
forming a first nonlinear optical grating comprising a plurality of NLO units disposed in series, wherein each NLO unit comprises a single crystal segment and a polycrystalline segment, the single crystal segment comprises a single crystal of a nonlinear optical material having a length adapted to provide a nonlinear effect, and the polycrystalline segment has a length adapted to compensate for phase mismatch occurring in the single crystal segment.

37. A method according to claim 36, wherein each NLO unit is formed to have a length substantially equal to nL_{c} where n is an even number.

38. A method according to claim 36, wherein the single crystal segment is formed to have a length substantially equal to xL_{c}, the polycrystalline segment is formed to have a length substantially equal to yL_{c}, and the total length of each NLO unit is substantially equal to nL_{c}, where x and y are odd numbers and n is an even number.

39. A method according to claim 38, wherein each NLO has substantially the same length.

40. A method according to claim 38, wherein x and y equal 1 and n equals 2.

41. A method according to claim 38, wherein the single crystal segment and polycrystalline segment have approximately the same length.

42. A method according to claim 38, wherein the single crystal segment is formed from a cubic, noncentrosymmetric nonlinear optical material and the polycrystalline segment is formed from the same nonlinear optical material as the single crystal segment.

43. A nonlinear optical device according to claim 36, wherein the single crystal segment has a length equal to xL_{c}, the polycrystalline segment has a length equal to yL_{c}, and the total length of each NLO unit is substantially equal to nL_{c}, where x and y are odd numbers or fractional numbers and n is an even number.

44. A method according to claim 36, further comprising shaping the first grating to define a core of a waveguide.

45. A method according to claim 44, wherein the core is sized to support single mode light propagation.

46. A method according to claim 36, further comprising forming a second nonlinear optical grating.

47. A method according to claim 36, wherein the first grating comprises a grating selected from the group consisting of a uniform grating, a fan-out grating, and a chirped grating.
